(19) United States
(12) Patent Application Publication
(10) Pub. No.: US 2009/0123757 A1
(43) Pub. Date: May 14, 2009

(54) LATENT-REACTIVE ADHESIVES FOR IDENTIFICATION DOCUMENTS

(75) Inventors: Heinz Pudleiner, Krefeld (DE); Joerg Buechner, Bergisch-Gladbach (DE); Mehmet-Cengiz Yesildag, Leverkusen (DE); Klaus Meyer, Dormagen (DE); Harald Kraus, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/269,180

(22) Filed: Nov. 12, 2008

(30) Foreign Application Priority Data
Nov. 13, 2007 (DE) 102007054046.0

(51) Int. Cl. B32B 27/08; B32B 27/40; B32B 27/36; B05D 5/12; B32B 27/32

(52) U.S. Cl. 428/412; 428/423.1; 428/423.7; 428/424.8; 428/423.3; 428/424.7; 427/97.6

(57) ABSTRACT

The present invention relates to an identification document having layer A), B) and C), wherein A) is a thermoplastic, B) is a layer produced from a stable, latent-reactive adhesive, and C) is a thermoplastic.

### RELATED APPLICATIONS

This application claims benefit to German Patent Application No. 10 2007 054 046, filed Nov. 13, 2007, which is incorporated herein by reference in its entirety for all useful purposes.

### BACKGROUND OF THE INVENTION

The present invention relates to an identification document having layer A), B) and C), wherein A) is a thermoplastic, B) is a layer produced from a stable, latent-reactive adhesive, and C) is a thermoplastic.

In the production of polycarbonate (PC)-based identification documents (ID documents), the problem arises that complex (electronic) components and also diffractive structures (inter alia holograms) are destroyed during the lamination process unless they are flexibly packaged. The problem has hitherto been avoided either by creating filled cavities in the immediate vicinity of the component or by using thermoelastic/thermoplastic buffer layers (for example thermoplastic polyurethane, TPU). This “soft” insert is intended to reduce mechanical stress during lamination. Owing to the chemically different nature of these materials, they represent a foreign body in principle and are thus a point of weakness in high-security documents.

With the incorporation of electronic components, in particular integrated circuits (ICs or chips), in polycarbonate (PC)-based documents, the use of thinned semiconductor structures gives rise to the problem of premature destruction of the component during lamination. In the well-known manufacture of PC smart cards by the lamination of individual film layers, a PC film is positioned directly over the chip. In the procedure established in industry, the prepared card structures are compressed under the simultaneous application of heat and pressure to form a “quasi-monolithic” block. Since the specific heat transfer coefficient of PC means that it does not soften immediately, the chip is directly exposed to an increased pressure, which in most cases leads to its mechanical destruction.

If self-adhesive films are applied to the electronic components, then it is perfectly possible for the desired elements to be joined together to form a card. As a rule, however, these adhesive layers are a weak point in the card structure: water vapour and air can easily diffuse inside via the edge of the card, leading to subsequent delamination. Other environmental influences, in particular temperature (variation), can also cause the card to split and thus become unusable.

Latent-reactive adhesives are known per se, for example from EP-A-0 922 720. In principle there are two solid phases in latent-reactive adhesives, for example as a mixture of two substances in the form of two types of crystals, which therefore do not react with one another at room temperature or under normal environmental conditions. The substances undergo a chemical reaction with one another only when activated, for example by heating.

In DE 31 12 054, DE 32 28 723 and DE 32 28 724, powdered, fine-particle solid polyisocyanates having particle diameters of up to 150 μm undergo surface deactivation. The surface coating means that the polyisocyanates retain their isocyanate content and their reactivity and form a stable one-component system even in water or aqueous solvents.

In DE 32 28 724 and DE 32 30 757, surface-deactivated powdered diisocyanates are combined with polyols and aqueous dispersion polymers containing functional groups to form a stable, reactive paste. If this water-containing paste is heated to 140° C., i.e. above the reaction temperature of the polyisocyanate, these two components crosslink and a readily foamed flexible coating is obtained.

A process for producing stable dispersions of fine-particle surface-deactivated isocyanates is described in DE 35 17 333. The resulting stable dispersions are suitable as crosslinking agents.

A use of aqueous dispersions of surface-deactivated solid, fine-particle polyisocyanates as crosslinkers in textile pigment printing pastes and dye baths is described in DE 35 29 530. Following the application process, the textile pigment printing pastes and dye baths are fixed to the fabric with hot air or steam.

The disadvantage of the systems described in these documents, however, is the fact that the application and curing or crosslinking steps cannot be performed separately, which in many applications appears to be desirable for both economic and logistical reasons.

Thus a substrate having a latent-reactive adhesive bearing a stable latent-reactive layer or powder would open up the possibility of being applied in the location where the corresponding equipment is present, being stored for a predefinable period of time and then being transported to the location where processing is carried out to form further intermediates or the end product.

Stable, latent-reactive materials or layers are described in WO 93/25599. These consist of isocyanate-reactive polymers having a melting point above 40° C. and surface-deactivated polyisocyanates. In order to produce the mixture, the components are melted at temperatures which are substantially above the softening point of the polymer. The equipment costs for producing and applying these materials and the energy costs are considerable. In addition, for stability and processing reasons, only surface-deactivated polyisocyanates having a crosslinking temperature of over 80° C. can be used in these systems. Furthermore, the application provides a selective and controlled non-homogeneous mixing of the components. This requires laborious process steps, however.

The object underlying the invention is therefore to provide new identification documents having improved security characteristics and a process for their production. The delamination characteristics in particular should be improved.

### EMBODIMENTS OF THE INVENTION

An embodiment of the present invention is an identification document comprising layer A), layer B), and layer C), wherein layer A) is a thermoplastic, layer B) is produced from a stable, latent-reactive adhesive, and layer C) is a thermoplastic.

Another embodiment of the present invention is the above identification document, wherein the adhesive of layer B comprises an aqueous dispersion comprising a diisocyanate or polyisocyanate having a melting point or softening point of greater than 30° C. and an isocyanate-reactive polymer.

Another embodiment of the present invention is the above identification document, wherein the adhesive of layer 1 comprises an aqueous dispersion having a viscosity of at least 2000 mPas.

Another embodiment of the present invention is the above identification document, wherein said isocyanate-reactive polymer is polyurethane synthesised from crystallising polymer chains which, when measured using thermomechanical analysis (TMA), partially or completely decrystallise at temperatures below 110° C., preferably at temperatures below +90° C. Measurements using thermomechanical analysis (TMA) are conducted analogous to ISO 11359-3, Part 3: “Determination of penetration temperature”.

Another embodiment of the present invention is the above identification document, wherein said polymer chains, when measured using thermomechanical analysis (TMA), partially or completely decrystallise at temperatures below 90° C.

Another embodiment of the present invention is the above identification document, wherein said diisocyanate or polyisocyanate is selected from the group consisting of dimerisation product, trimerisation product, urea derivatives of TDI, and urea derivatives of IPDI.

Another embodiment of the present invention is the above identification document, comprising a bonded joint produced by applying said dispersion to the substrate to be bonded, drying it, decrystallising the dried adhesive layer by heating it briefly at temperature greater than 65° C. and joining said layer in the decrystallised state to the substrate to be joined.

Another embodiment of the present invention is the above identification document wherein said decrystallization is achieved by heating the dried adhesive layer for less than five minutes at a temperature between 80° C. and 110° C.

Another embodiment of the present invention is the above identification document, wherein said thermoplastic in layer A) and said thermoplastic in layer C) are independently selected from the group consisting of polyearbonate, polylmethyl methacrylate, styrene polymers, styrene copolymers, transparent thermoplastic polyurethanes, polyolefins, polycondensates of terephthalic acid, copolycondensates of terephthalic acid, polyethylene glycol naphthenate, and transparent polysulfones.

Another embodiment of the present invention is the above identification document wherein said thermoplastic in layer A) and said thermoplastic in layer C) are independently selected from the group consisting of transparent polystyrene, polystyrene acrylonitrile, transparent polypropylenes, polyolefins based on cyclic olefins, polyethylene terephthalate, copolyethylene terephthalate, and glycol-modified polyethylene terephthalate.

Another embodiment of the present invention is the above identification document, wherein said thermoplastic in layer A) and said thermoplastic in layer C) are independently selected from the group consisting of polycarbonate, polycondensates of terephthalic acid, and copolycondensates of terephthatic acid.

Another embodiment of the present invention is the above identification document, wherein said thermoplastic in layer A) and said thermoplastic in layer C) are independently selected from the group consisting of polycarbonate, polyethylene terephthalate, copolyethylene terephthalate, and glycol-modified polyethylene terephthalate.

Yet another embodiment of the present invention is a process for producing the above identification document comprising i) mixing a substantially aqueous dispersion or solution having an isocyanate-reactive polymer with a water-suspended surface-deactivated polyisocyanate to produce a mixture, ii) applying said mixture of i) to a layer C), iii) removing water from the mixture of i) below the reaction temperature of the diisocyanate or polyisocyanate to form a layer B), and iv) applying a layer C) to said layer B).

Another embodiment of the present invention is the above process, wherein said water is removed at a temperature below the reaction temperature of the isocyanate such that the resulting layers are substantially dry and solid and are latently reactive at temperatures below the reaction temperature of polyisocyanate and polymers.

Yet another embodiment of the present invention is the above identification document, further comprising an electronic component.

Another embodiment of the present invention is the above identification document, wherein said electronic component is an integrated circuit.

### DESCRIPTION OF THE INVENTION

This object is achieved according to the invention by means of an identification document having layer A), B) and C), wherein A) is a thermoplastic, B) is a layer produced form a stable, latent-reactive adhesive, and C) is a thermoplastic.

Within the context of the present invention, “identification document” denotes a multilayer, flat document having security features such as chips, photographs, biometric data, etc. These security features may be visible or may at least be able to be scanned from the outside. The size of the identification document is normally between that of a cheque card and a passport. The identification document can also be part of a multi-part document, such as a plastic identification document in a passport which also contains paper or cardboard elements, for example.

In a further embodiment the present invention relates to such an identification document characterised in that the adhesive contains an aqueous dispersion containing a diisocyanate or polyisocyanate having a melting point or softening point of >30° C. and an isocyanate-reactive polymer.

In a further embodiment the present invention relates to such an identification document characterised in that the adhesive contains an aqueous dispersion having a viscosity of at least 2000 mPas.

In a further embodiment the present invention relates to such an identification document characterised in that the isocyanate-reactive polymer is polyurethane, which is synthesised from crystallising polymer chains which, when measured using thermomechanical analysis (TMA), decrystallise partially or completely at temperatures below +110° C., preferably at temperatures below +90° C.

In a further embodiment the present invention relates to such an identification document characterised in that the diisocyanate or polyisocyanate is selected from the group consisting of dimerisation product, trimerisation product and urea derivatives of TDI or IPDI.

In a further embodiment the present invention relates to such an identification document characterised in that a bonded joint is produced by applying a dispersion according to claim 1 to the substrate to be bonded and then drying it, and then decrystallising the dried adhesive layer by heating it briefly, preferably for less than five minutes, at T>65° C., preferably at a temperature of 80° C.<T<110° C., and joining it in the decrystallised state to the substrate to be joined.

Within the context of the present invention, “thermoplastic” denotes a thermoplastic having polymer chains, such as for example polycarbonate, polymethyl methacrylate (PMMA), polymers or copolymers with styrene, such as for example and preferably transparent polystyrene (PS) or polystyrene acrylonitrile (SAN), transparent thermoplastic polyurethanes, and polyolefins, such as for example and preferably transparent polypropylene types or polyolefins based on cyclic olefins (e.g. TOPAS®, Topas Advanced Polymers), polycondensates or copolycondensates of terephthalic acid, such as for example and preferably polyethylene or copolyethylene terephthalate (PET or CoPET) or glycol-modified PET (PETG), polyethylene glycol naphthenate (PEN), transparent polysulfones (PSU).

In a further embodiment the present invention relates to such an identification document characterised in that the thermoplastic in layer A) and layer C) is mutually independently selected from the group consisting of polycarbonate, polycondensates or copolycondensates of terephthalic acid, such as for example and preferably polyethylene or copolyethylene terephthalate (PET or CoPET) or glycol-modified PET (PETG).

Laminates for in particular high-security ID card applications having at least one stable, latent-reactive layer can accordingly be produced by the use of a substantially aqueous dispersion containing at least one surface-deactivated polyisocyanate and at least one dispersed or dissolved isocyanate-reactive polymer.

The invention also provides a process for producing laminates having at least one stable, latent-reactive layers wherein
a) a substantially aqueous dispersion or solution consisting of at least one isocyanate-reactive polymer and
b) at least one substantially water-suspended surface-deactivated, solid, fine-particle polyisocyanate are mixed together,
c) this mixture is optionally applied to a substrate in a predefinable film thickness and
d) the water is removed from the mixture below the reaction temperature of the isocyanate,
   such that the substantially dry and anhydrous layers or materials obtained in this way are stable and latently reactive at reaction temperatures below the reaction temperature of polyisocyanate and polymer.

Surprisingly it was found that removal of the water and drying of the mixture can take place in the temperature range optionally
i) between room temperature and the softening point of the functional polymer or
ii) above the softening point of the polymer,
   provided that the reaction temperature of the surface-deactivated polyisocyanate is not exceeded in either case. Regardless of whether drying is performed in accordance with i) or ii), after drying, the surface-deactivated solid, fine-particle polyisocyanates are distributed and embedded in unchanged and unreacted form in the largely anhydrous polymer or in the substantially anhydrous layer or powder. The dispersion, suspension or solution of polymer and suspended deactivated isocyanate is converted into a continuous phase of uncrosslinked polymer in which the unreacted surface-deactivated, fine-particle isocyanates are suspended.

Case i) results in an anhydrous, dry, latent-reactive film or a latent-reactive powder which is capable of being stored at room temperature or at slightly elevated temperature. The reactivity of the surface-deactivated isocyanates with the functional groups of the polymer is retained.

Case ii) results in a molten system after the water has been evaporated off. The bonding of a laminate consisting of films serves as an example. In this phase too the surface-deactivated isocyanates are unchanged and retain their reactivity. The bond is based initially on the thermoplastic properties of the polymer.

In both cases the system crosslinks and becomes infusible and insoluble only when the reaction temperature of the surface-deactivated isocyanate is exceeded. This occurs after a predefinable period of time.

In certain cases it is sufficient for the reaction temperature to be exceeded for only a short time in order to trigger the crosslinking reaction. The reaction or thickening temperatures of the deactivated polyisocyanates should be temperatures in the range from 30° C. to 180° C., preferably in the range from 40° C. to 150° C.

The thickening or reaction temperature is the temperature at which the surface-deactivating layer of isocyanate in the polymer dissolves or is destroyed by other means. The polyisocyanate is released and dissolved in the polymer. Final curing takes place by diffusion and reaction of the polyisocyanate with the functional groups of the polymer with a rise in viscosity and crosslinking. Depending on the type of surface-deactivated polyisocyanate, the thickening and reaction temperature is above or below the softening point of the polymer.

The stability of the unreacted system, the reaction temperature and the reaction course are determined by the type of polyisocyanate, the type and amount of surface stabiliser, the solubility parameter of the functional polymer and by catalysts, plasticisers and other auxiliary agents. These are extensively described in the patent documents referred to in the introduction.

The invention also provides post-application machining steps for the substrate bearing the layer or powder. These include steps such as are necessary for example for machining the substrate into its final form by means of punching, cutting to size, bending, folding, laminating, etc. It has furthermore surprisingly been established that the film or powder according to the invention can be processed in its plastic state. Even after days or months, the layer or powder can be heated to temperatures above the softening point of the polymer without initiating a reaction between the functional groups of the polymer and the surface-deactivated isocyanates. Processing in the plastic state can even be performed with repeated heating and cooling.

In a preferred embodiment the films or powders are stable, latent-reactive adhesive systems.

If such latent-reactive self-adhesive films are applied to the electronic components, it is perfectly possible for the desired elements to be joined together to form a card. These adhesive layers according to the invention no longer represent a weak point in the card structure, since they no longer allow water vapour and air to diffuse inside via the card edge and thus can no longer lead to subsequent delamination. Such card structures can no longer be separated without being destroyed.

All diisocyanates or polyisocyanates or mixtures thereof are suitable as polyisocyanates for the process according to the invention provided that they have a melting point above 40° C. and can be converted by known methods into powder form with particle sizes below 200 μm. They can be aliphatic, cycloaliphatic, heterocyclic or aromatic polyisocyanates. The following can be cited by way of example: diphenylmethane-4,4′-diisocyanate (MDI), naphthalene-1,5-diisocyanate (NDI), 3,3′-dimethylbiphenyl-4,4′-diisocyanate (TODI), diimeric 1-methyl-2,4-phenylene diisocyanate (TDI-U), 3,3′-diisocyanato-4,4′-dimethyl-N,N′-diphenyl urea (TDIH), addition product of 2 moles of 1-methyl-2,4-phenylene diisocyanate with 1 mole of 1,2-ethanediol, 1,4-butanediol, 1,4-cyclohexane dimethanol, or ethanolamine, the isocyanurate of IPDI (IPDI-T).

The cited addition products exhibit the advantages according to the invention not only as aqueous dispersions. Addition products consisting of 1-methyl-2,4-phenylene diisocyanate and 1,4-butanediol or 1,2-ethanediol have very advantageous properties even in solid and liquid solvent-containing or solvent-free systems. These are illustrated above all in terms of their low curing or crosslinking temperature, which is in the temperature range below 90° C. The use of this mixture, whether based largely on water or polyol, is therefore very advantageous for coatings and bonds for temperature-sensitive substrates.

The surface stabilisation reaction can be performed in various ways:

By dispersing the powdered isocyanate in a solution of the deactivating agent.

By introducing a melt of a low-melting polyisocyanate into a solution of the deactivating agent in a non-dissolving liquid dispersing agent.

By adding the deactivating agent or a solution thereof to the dispersion of the solid, fine-particle isocyanates.

The concentration of the deactivating agent should be 0.1 to 25, preferably 0.5 to 8 equivalent percent, relative to the total isocyanate groups present.

For the use according to the invention the particle size of the powdered polyisocyanates often has to be adjusted to a particle size in the range from 0.5 to 20 μm by means of a fine dispersion or wet grinding stage following the synthesis.

High-speed mixers, dispersing devices of the rotor-stator type, attrition mills, pearl and sand mills, ball mills and grinding gap mills are suitable for this purpose, at temperatures below 40° C. Depending on the polyisocyanate and the use, grinding is carried out on the deactivated polyisocyanate, in the presence of the deactivating agent, in the non-reactive dispersing agent or water with subsequent deactivation. The ground and surface-stabilised polyisocyanate can be separated from the grinding dispersions and dried.

Catalysts can also be added in order to control the surface deactivation and crosslinking reaction. Catalysts which are resistant to hydrolysis in aqueous solution or dispersion and which subsequently then also accelerate the heat-activated reaction are preferred. Examples of urethane catalysts are organic tin, iron, lead, cobalt, bismuth, antimony, zinc compounds or mixtures thereof. Alkyl mercaptide compounds of dibutyl tin are preferred because of their elevated hydrolysis resistance.

Tertiary amines such as dimethyl benzylamine, diazabicycloundecane and non-volatile polyurethane foam catalysts on a tertiary amine basis can be used for special purposes or in combination with metal catalysts, although the catalytic activity can be adversely affected by reaction with atmospheric carbon dioxide.

The concentration of catalysts is in the range from 0.001 to 3%, preferably 0.01% to 1%, relative to the reactive system.

The aqueous dispersions for the preparations according to the invention preferably contain polyurethane or polyurea dispersions with crystalline polyester soft segments as the isocyanate-reactive dispersion polymer. Dispersions of isocyanate-reactive polyurethane polymers of crystalline or partially crystalline polymer chains are particularly preferred which when measured by means of thermomechanical analysis at least partially decrystallise at temperatures of between 50° C. and 120° C.

The acrylate dispersion polymers can also optionally be mentioned, but the focus is on polyurethane or polyurea dispersion polymers with crystalline polyester soft segments.

Water-soluble or water-dispersible emulsion or dispersion polymers bearing isocyanate-reactive functional groups are suitable as reaction partners according to the invention of the polyisocyanates. These are produced according to the prior art by polymerisation of olefinically unsaturated monomers in solution, emulsion or suspension. The film-forming polymers contain 0.2 to 15%, preferably 1 to 8%, of monomers incorporated by polymerisation having isocyanate-reactive groups such as hydroxyl, amino, carboxyl, carbonamide groups.

Examples of such functional monomers are: allyl alcohol, hydroxyethyl or hydroxypropyl acrylate and methacrylate, butanediol monoacrylate, ethoxylated or propoxylated acrylates or methacrylates, N-methylol acrylamide, tert-butyl aminoethyl methacrylate, acrylic and methacrylic acid, maleic acid, maleic acid monoester. Glycidyl methacrylate and allyl glycidyl ether can also be copolymerised. These contain an epoxy group which is derivatised in a further step with amines or amine alcohols to form the secondary amine, for example with ethylamine, ethylhexylamine, isononylamine, aniline, toluidine, xylidine, benzylamine, ethanolamine, 3-amino-1-propanol, 1-amino-2-propanol, 5-amino-1-pentanol, 6-amino-1-hexanol, 2-(2-aminoethoxy)ethanol.

This reaction increases the reactivity of the functional groups of the polymer with the isocyanate groups, to the detriment of the secondary reaction with water.

Also suitable are water-soluble hydroxy-functional binders such as polyvinyl alcohol, partially saponified polyvinyl acetate, hydroxyethyl cellulose, hydroxypropyl cellulose, and water-dispersible hydroxy-functional polyesters, hydroxy-functional sulfopolyesters, and polyurethane dispersions, dispersions of polyamidoamines bearing carboxyl or hydroxyl primary or secondary amino groups. Aqueous colloidal dispersions or colloidal solutions with particle sizes between 1 and 100 nm can likewise be produced in colloid mills, starting from thermoplastic polymers with isocyanate-reactive groups. Examples include higher-molecular-weight solid epoxy resins, polyethylene vinyl alcohol and polyethylene co-acrylic acid.

Further inert or functional additives can be incorporated or dispersed in the resulting high-viscosity paste or low-viscosity mixture. The functional additives include hydroxy-functional or amino-functional powdered or liquid low-molecular-weight to high-molecular-weight compounds, which can react with the solid polyisocyanates above the reaction temperature. The stoichiometric ratios must be adjusted accordingly. Low-molecular-weight compounds are understood to be compounds having molecular weights of between 40 and 500 g/mol, while high-molecular-weight compounds are understood to be those whose molecular weights are between 500 and 10,000 g/mol. Examples which can be mentioned include: low-molecular-weight to high-molecular-weight liquid polyols or/and polyamines, solid polyfunctional polyols or/and aromatic polyamines. Examples are triethanolainine, butanediol, trimethylol propane, ethoxylated bisphenol A, end-ethoxylated polypropylene glycols, 3,5-diethyl toluoylene-2,4- and 2,6-diamine, polytetramethlyene oxide di-(p-aminobenzoate), tris-hydroxyethyl isocyanurate, hydroquinone bis-hydroxyethyl ether, pentaerythritol, 4,4′-diaminobenzanilide, 4,4′-methylene bis-(2,6-diethyl aniline).

The inert additives include, for example, wetting agents, organic or inorganic thickeners, plasticisers, fillers, plastic powders, pigments, dyes, light stabilisers, ageing stabilisers, anti-corrosive agents, flame retardants, blowing agents, adhesive resins, organofunctional silanes, chopped fibres and optionally small amounts of inert solvents.

The advantages of the present invention lie in the separation of the application of the aqueous dispersion from the crosslinking reaction, i.e; the final curing. In this way, for example, adhesive films can be applied to wood, glass or other substrates or supports in one location, these prefabricated products can be stored and/or shipped and cured at another location to form the end product.

A further advantage of the process according to the invention and the use of the corresponding products lies in the use of water as the dispersion medium. The energy consumption for producing the dispersions is low. The proportion of organic solvents is minimal, which from an environmental protection perspective results in very advantageous processing.

If an aqueous polymer dispersion is used as the starting point, a further advantage lies in the fact that surface-deactivated polyisocyanates having a melting point in the range from 40 to 150° C. can also be incorporated without problem. The crosslinking temperatures can be in the range from 35° C. to 90° C. With these low crosslinking temperatures even temperature-sensitive substrates can be bonded with this one-component system under exposure to heat.

The layer or powder obtained from the aqueous suspension, dispersion or solution can be stored for months. The storage period at room temperature or at slightly elevated temperatures differs, however, depending on the solution characteristics of the solid film for the polyisocyanate. The storage period for the system according to the invention in the anhydrous and uncrosslinked state is at least three times, conventionally more than ten times that of the same mixture with the same polyisocyanates which are not surface-deactivated. At +2° C. the layers or powders according to the invention are stable for at least six months, at room temperature for at least one month, however, and are able to be processed according to the invention. The term “latent-reactive” denotes the state of the substantially anhydrous layer or powder in which the surface-deactivated polyisocyanate and the isocyanate-reactive polymer are present in the substantially uncrosslinked state.

The heat for thermoplastic processing and for crosslinking can preferably be supplied by convection heat or radiant heat. The stable aqueous suspension, dispersion or solution of surface-deactivated fine-particle polyisocyanates and dispersed or water-soluble polymers with isocyanate-reactive groups can be applied to the surface of the substrate to be bonded or coated, in particular by brushing, spraying, atomising, knife application, trowel application, pouring, dipping, extruding or by roller application or by printing.

Suitable substrates for the laminates according to the invention are thermoplastics such as polycarbonates or copolycarbonates based on diphenols, polyacrylates or copolyacrylates and polymethacrylates or copolymethacrylates, such as for example and preferably polymethyl methacrylate (PMMA), polymers or copolymers with styrene, such as for example and preferably transparent polystyrene (PS) or polystyrene acrylonitrile (SAN), transparent thermoplastic polyurethanes, and polyolefins, such as for example and preferably transparent polypropylene types or polyolefins based on cyclic olefins (e.g. TOPAS®, Topas Advanced Polymers), polycondensates or copolycondensates of terephthalic acid, such as for example and preferably polyethylene or copolyethylene terephthalate (PET or COPET) or glycol-modified PET (PETG), polyethylene glycol naphthenate (PEN), transparent polysulfones (PSU).

If substrates are to be bonded, it is possible to proceed in one of the following ways:

1. Press bonding by joining the surfaces to be bonded at room temperature and raising the temperature to above the softening point of the polymer but below the reaction temperature, then cooling to room temperature. A bond is formed which is latently reactive. This bond can be processed further and shaped, even in the plastic or thermoplastic range of the polymer. The bond attains its final crosslinked state when the temperature is raised to above the thickening or reaction temperature.
2. Press bonding by joining the surfaces to be bonded at room temperature and raising the temperature to above the softening point of the polymer, forming a homogeneous adhesive film which wets and bonds the opposite surface, raising the temperature to above the thickening or reaction temperature and final crosslinking.
3. The coated surface to be bonded is brought into the thermoplastic state by raising the temperature to above the softening point of the polymer, joined to a second substrate and the temperature raised to above the thickening or reaction temperature while exerting pressure. Further processing steps can optionally be performed while the system is in the thermoplastic state.

In a second embodiment of the process the stable aqueous dispersion of surface-deactivated fine-particle polyisocyanates and dispersed or water-soluble polymers with isocyanate-reactive groups are brought into the form of a latent-reactive adhesive film, adhesive tape, adhesive nonwoven or adhesive woven fabric which can establish adhesion on both sides. In order to produce backing-free forms such as films or tapes, the dispersion according to the invention is applied to a non-adhesive backing tape or release paper and the water is volatilised at room temperature or at temperatures up to the softening point of the polymer. After cooling, the adhesive film can be detached from the backing and stored without a backing until use. Alternatively the adhesive film can be stored together with the backing paper.

In the case of adhesive nonwoven or woven fabrics, the reactive dispersion is applied by spraying, atomising, knife application, pouring, dipping, padding, by roller application or by printing, the water is volatilised at room temperature or at temperatures up to the softening point of the polymer and the adhesive nonwoven or woven fabric, provided or impregnated with the latently heat-reactive adhesive layer, is stored until use.

The backing-free adhesive films, adhesive tapes, adhesive nonwoven or woven fabrics are used as an adhesive layer between substrates. It is also possible to apply or to sinter adhesive films, nonwoven or woven fabrics to one side of a substrate surface in the plastic state. This laminate can be stored at room temperature until it is finally bonded to a second substrate surface.

In a third embodiment of the process the stable aqueous dispersion of surface-deactivated fine-particle polyisocyanates and dispersed or water-soluble polymers with isocyanate-reactive groups is brought into the form of a latent-reactive powder. These powders can be used as latent-reactive adhesives or for coating purposes, such as powder coatings.

In order to produce powders from the dispersions according to the invention they can be sprayed in a spray drying tower. The temperature of the air introduced from below should remain below the softening point of the polymer and the reaction temperature of the surface-blocked polyisocyanate.

Alternatively the dispersions according to the invention can be sprayed onto the non-adhesive surface of a circulating belt with dehesive surfaces or applied by means of a printing process. After volatilisation of the water the dry particles are scraped off the tape, optionally screened and classified, and stored until use.

Latent-reactive powders can also be produced from backing-free films or tapes by grinding processes, optionally at low temperatures. They are used as heat-reactive crosslinkable adhesive or coating powders. Application equipment and methods are prior art and are known to the person skilled in the art.

The latent-reactive prefabricated layers produced by the process according to the invention are preferably used as a high temperature-resistant bonded joint for flexible or solid substrates, such as for example metals, plastics, glass, wood, wood composites, card, films, synthetic flat materials, textiles.

The reactive coating powders produced according to the invention can also be processed by the application methods for powder coatings. Depending on the choice of polyisocyanate, the crosslinking temperature can be so low that heat-sensitive substrates such as plastics, textiles and wood can be coated without thermal damage. The process also allows the coating powders to be sintered only or to be melted on the substrate to form a closed layer. Complete crosslinking then takes place in a subsequent heat treatment process, optionally after an additional mechanical or thermal processing step.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### A) Commercial Products Used

### Dispercoll® U 53

Polyurethane dispersion from Bayer MaterialScience AG, 51368 Leverkusen, Germany; solids content approx. 40 wt. %; isocyanate-reactive polymer consisting of linear polyurethane chains. The polymer crystallises after drying the dispersion and cooling the film to 23° C., When measured using thermomechanical analysis (TMA) the film is largely decrystallised at temperatures below +65° C.

### Desmodur® DN

Solvent-free hydrophilically modified crosslinker isocyanates based on MI trimers. NCO content approx. 20%, viscosity approx. 1200 mPas at 23° C.

### Dispercoll® BL XP2514

Suspension of surface-deactivated TDI uretdione (TDI dimer) in water with a solids content of approx. 40%.

### Disercoll® U VP KA 8755

Polyurethane dispersion from Bayer MaterialScience AG, 51368 Leverkusen, Germany; solids content approx. 40 wt. %; isocyanate-reactive polymer consisting of linear polyurethane chains. The polymer crystallises after drying the dispersion and cooling the film to 23° C. When measured using thermomechanical analysis (TMA) the film is largely decrystallised at temperatures below +65° C.

### Borchi® Gel L 75 N

Non-ionic, liquid, aliphatic polyurethane-based thickener: viscosity at 23° C.: >9000 mPas; non-volatile components: approx. 50 wt. %.

### Aqua Press® ME

Commercial milky white dispersion from Pröll.

### Borchi® Gel ALA

Aqueous solution of an anionic, acrylate-based thickener: viscosity at 20° C. (Brookfield, LVT, hydrometer IV, 6 rpm): 25,000 to 60,000 mPas; non-volatile components: approx. 10 wt. %.

### Dispercoll Laboratory Product KRAU 2756 K-1

Polyurethane dispersion from Bayer MaterialScience AG, 51368 Leverkusen, Germany; solids content approx. 45 wt. %; isocyanate-reactive polymer consisting of linear polyurethane chains.

The polymer partially crystallises after drying the dispersion and cooling the film to 23° C. When measured using thermomechanical analysis (TM) the film is largely decrystallised at temperatures below +65° C.

Measurements using thermomechanical analysis (TMA) were conducted analogous to ISO 11359-3, Part 3: “Determination of penetration temperature”.

### B) Storage Conditions

### Storage A

Application of the dispersion at room temperature, removal of much of the water by evaporation at room temperature on the film, after max. 3 hours immediate lamination of the surfaces to be bonded at 90° C. or 120° C. (object temperature), triggering the crosslinking reaction. Cooling and storage for 24 hours under normal conditions.

### Storage B

Application of the dispersion at room temperature, removal of much of the water by evaporation at room temperature on the film, storage for 1 day under normal conditions, then lamination at 90° C. or 120° C. (object temperature), triggering the crosslinking reaction. Cooling and storage for 24 hours under normal conditions.

### Storage C

Application of the dispersion at room temperature, removal of much of the water by evaporation at room temperature on the film, storage for 7 days under normal conditions, then lamination at 90° C. or 120° C. (object temperature), triggering the crosslinking reaction. Cooling and storage for 24 hours under normal conditions.

### Storage D

Application on a film, removal of much of the water by evaporation at room temperature. The surface coated with the adhesive layer is left open in air for 21 days. Then lamination at 90° C. or 120° C. (object temperature), triggering the crosslinking reaction. Cooling and storage for 24 hours under normal conditions.

### C) Sample Production and Test Method

Testing of the adhesive strength of the bond between two films in accordance with the separation test defined by DIN 53 357:

Specimens measuring 200×50×0.15 mm³ consisting of two films were overlapped in a single layer and press bonded (laminated). The films are left separate for a length of approximately 40 mm to create two tongues, which can be clamped in the clamps of a tensile testing machine. The surface to be bonded measures approx. 160×50 mm². The strength of the bond was measured at 120° C.

Divergent or different test conditions or tests are specified.

### D) Application and Testing of the Reactive Adhesive Dispersions

Adhesive dispersions used:

Production of the adhesive dispersion. General instructions:

The viscosity of the Dispercoll U dispersion is first increased using a thickener.

| | Parts by weight |
|---|---|
| Dispercoll ® U 53 | 100 |
| Borchigel ® ALA | 2 |

Then 5 to 10 parts by weight of a deactivated polyisocyanate are added to 100 parts by weight of Dispercoll U 53 while stirring, to give the following aqueous suspensions:

A reactive dispersion adhesive was produced with the specified polyisocyanates in a high-speed mixer as follows:

| | Parts by weight |
|---|---|
| Example 1 (comparative example; not | |
| according to the invention) | |
| Dispercoll ® U 53 | 100 |
| Borchigel ® ALA | 2 |
| Example 2 (according to the invention) | |
| Dispercoll ® U 53 | 100 |
| Borchigel ® ALA | 2 |
| Desmodur ® DN | 5 |
| Example 3 (according to the invention) | |
| Dispercoll ® U 53 | 100 |
| Borchigel ® ALA | 2 |
| Dispercoll ® BL XP 2514 | 10 |
| Example 4 | |
| Dispercoll ® U 53 | 100 |
| Borchigel ® ALA | 2 |
| IPDI trimer formulation (3 eq. % amino | 20 |
| groups from Jeffamine T-403) | |

### Example 5

### Comparative Example; Not According to the Invention

Aqua Press® commercial aqueous one-component coupling agent from Proll K G, Weiβenburg, Germany.

### Example 6

The adhesive mixtures from examples 1 to 5 were applied with a spiral knife to Makrofol® ID 6-2 (polycarbonate film textured on both sides, from Bayer MaterialScience AG, specifically for identification cards, 6 side: roughness R₃z approx. 9 μm; 2 side: R₃z approx. 4 μm) of thickness 150 μm in a wet film thickness of 1100 μm. The films were dried under normal conditions.

After the specified storage A to C, each of the coated films was laminated to an uncoated Makrofol® ID 6-2, 150 μm film and tested as described in section C). Lamination was carried out under mechanical pressure of 2 kp/cm² at 90° C. and 120° C. (press bonding).

Then the separation test was used to test the mechanical strength of the bond as a function of storage A to C (storage period) and temperature.

| | | | Lamination | |
|---|---|---|---|---|
| Example | | Storage | temperature | Mean N/cm |
| Example 1 | Not according to the | A | 90 | 1.03 |
| | invention | | | |
| Example 1 | Not according to the | B | 90 | 0.46 |
| | invention | | | |
| Example 1 | Not according to the | C | 90 | 1.38 |
| | invention | | | |
| Example 1 | Not according to the | A | 120 | 0.80 |
| | invention | | | |
| Example 1 | Not according to the | B | 120 | 0.88 |
| | invention | | | |
| Example 1 | Not according to the | C | 120 | 0.66 |
| | invention | | | |
| Example 2 | According to the | A | 90 | 8.67 |
| | invention | | | |
| Example 2 | According to the | B | 90 | 6.54 |
| | invention | | | |
| Example 2 | According to the | C | 90 | 2.64 |
| | invention | | | |
| Example 2 | According to the | A | 120 | 4.95 |
| | invention | | | |
| Example 2 | According to the | B | 120 | 3.21 |
| | invention | | | |
| Example 2 | According to the | C | 120 | 2.51 |
| | invention | | | |
| Example 3 | According to the | A | 90 | 11.57 |
| | invention | | | |
| Example 3 | According to the | B | 90 | 13.24 |
| | invention | | | |
| Example 3 | According to the | C | 90 | 13.42 |
| | invention | | | |
| Example 3 | According to the | A | 120 | 10.48 |
| | invention | | | |
| Example 3 | According to the | B | 120 | 17.90 |
| | invention | | | |
| Example 3 | According to the | C | 120 | 14.77 |
| | invention | | | |
| Example 4 | According to the | A | 90 | 3.52 |
| | invention | | | |
| Example 4 | According to the | B | 90 | 5.84 |
| | invention | | | |
| Example 4 | According to the | C | 90 | 5.99 |
| | invention | | | |
| Example 4 | According to the | A | 120 | 3.28 |
| | invention | | | |
| Example 4 | According to the | B | 120 | 4.26 |
| | invention | | | |
| Example 4 | According to the | C | 120 | 2.59 |
| | invention | | | |
| Example 5 | Not according to the | A* | 90 | 1.54 |
| | invention | | | |
| Example 5 | Not according to the | A* | 120 | 0.93 |
| | invention | | | |

*Since even the initial strength was not present, further storage was dispensed with.

With the best system from example 3 further tests relating to the storage stability of the coated films were performed.

| | Parts by weight |
|---|---|
| Example 7 | |
| Dispercoll ® VP KA 8755 | 700 |
| Borchigel ® L 75 N | 7 |
| Dispercoll ® BL XP 2514 | 70 |
| Example 8 | |
| KRAU 2756 K-1 | 700 |
| Borchigel ® L 75 N | 7 |
| Dispercoll ® BL XP 2514 | 70 |

The adhesive mixtures from examples 7 to 8 were applied with a spiral knife to Makrofol® ID 1-1 (polycarbonate film, smooth on both sides, from Bayer MaterialScience AG, specially for identification cards) of thickness 250 μm in a wet film thickness of 50 μm. The films were dried in a vacuum drying cabinet at 50° C.

After the specified storage A and D, each of the coated films was laminated to an uncoated Makrofol® ID 1-1, 250 μm film and tested as described in section C). Lamination was carried out under mechanical pressure of 2 kp/cm² at 120° C. and 135° C. (press bonding).

Then the separation test was used to test the mechanical strength of the bond as a function of storage A and D (storage period) and temperature.

| | | | Lamination | |
|---|---|---|---|---|
| Example | | Storage | temperature | Mean N/cm |
| Example 7 | According to the | A | 120 | 31.30 |
| | invention | | | |
| Example 7 | According to the | D | 120 | 71.04 |
| | invention | | | |
| Example 7 | According to the | A | 135 | 73.59 |
| | invention | | | |
| Example 7 | According to the | D | 135 | 140.41 |
| | invention | | | |
| Example 8 | According to the | A | 120 | 55.82 |
| | invention | | | |
| Example 8 | According to the | D | 120 | 63.36 |
| | invention | | | |
| Example 8 | According to the | A | 135 | 38.87 |
| | invention | | | |
| Example 8 | According to the | D | 135 | 95.02 |
| | invention | | | |

Even after being stored for 21 days, the laminates with the adhesive compositions according to examples 7 and 8 were still characterised by the formation of a very firm bonded joint. Even better bonds were achieved at the activation temperature of 135° C. than at 120° C.

After the separation test the surfaces of the bonded films were so badly damaged that any further use of such surfaces was excluded. A substantial goal for use in security cards is thus achieved: a thermal separation of bonded layers without damage is excluded with the adhesives used in the examples according to the invention.

1. An identification document comprising layer A), layer B), and layer C), wherein layer A) is a thermoplastic, layer B) is produced from a stable, latent-reactive adhesive, and layer C) is a thermoplastic.

2. The identification document of claim 1, wherein the adhesive of layer B comprises an aqueous dispersion comprising a diisocyanate or polyisocyanate having a melting point or softening point of greater than 30° C. and an isocyanate-reactive polymer.

3. The identification document of claim 2, wherein the adhesive of layer B comprises an aqueous dispersion having a viscosity of at least 2000 mPas.

4. The identification document of claim 2, wherein said isocyanate-reactive polymer is polyurethane synthesised from crystallising polymer chains which, when measured using TV, partially or completely decrystallise at temperatures below 110° C.

5. The identification document of claim 4, wherein said polymer chains, when measured using TMA, partially or completely decrystallise at temperatures below 90° C.

6. The identification document of claim 2, wherein said diisocyanate or polyisocyanate is selected from the group consisting of dimerisation product, trimerisation product, urea derivatives of TDI, and urea derivatives of IPDI.

7. The identification document of claim 2, comprising a bonded joint produced by applying said dispersion to the substrate to be bonded, drying it, decrystallising the dried adhesive layer by heating it briefly at temperature greater than 65° C. and joining said layer in the decrystallised state to the substrate to be joined.

8. The identification document of claim 7, wherein said decrystallization is achieved by hating the dried adhesive layer for less than five minutes at a temperature between 80° C. and 110° C.

9. The identification document of claim 1, wherein said thermoplastic in layer A) and said thermoplastic in layer C) are independently selected from the group consisting of polycarbonate, polymethyl methacrylate, styrene polymers, styrene copolymers, transparent thermoplastic polyurethanes, polyolefins, polycondensates of terephthalic acid, copolycondensates of terephthalic acid, polyethylene glycol naphthenate, and transparent polysulfones.

10. The identification document of claim 9, wherein said thermoplastic in layer A) and said thermoplastic in layer C) are independently selected from the group consisting of transparent polystyrene, polystyrene acrylonitrile, transparent polypropylenes, polyolefins based on cyclic olefins, polyethylene terephthalate, copolyethylene terephthalate, and glycol-modified polyethylene terephthalate.

11. The identification document of claim 1, wherein said thermoplastic in layer A) and said thermoplastic in layer C) are independently selected from the group consisting of polycarbonate, polycondensates of terephthalic acid, and copolycondensates of terephthalic acid.

12. The identification document of claim 11, wherein said thermoplastic in layer A) and said thermoplastic in layer C) are independently selected from the group consisting of polycarbonate, polyethylene terephthalate, copolyethylene terephthalate, and glycol-modified.

13. A process for producing the identification document of claim 1, comprising:
i) mixing a substantially aqueous dispersion or solution having an isocyanate-reactive polymer with a water-suspended surface-deactivated polyisocyanate to produce a mixture;
ii) applying said mixture of i) to a layer C);
iii) removing water from the mixture of i) below the reaction temperature of the diisocyanate or polyisocyanate to form a layer B); and
iv) applying a layer C) to said layer B).

14. The process of claim 13, wherein said water is removed at a temperature below the reaction temperature of the isocyanate such that the resulting layers are substantially dry and solid and are latently reactive at temperatures below the reaction temperature of polyisocyanate and polymers.

15. The identification document of claim 1, further comprising an electronic component.

16. The identification document of claim 15, wherein said electronic component is an integrated circuit.
